(19) United States
(12) Patent Application Publication
(10) Pub. No.: US 2024/0399944 A1
(43) Pub. Date: Dec. 5, 2024

(54) VEHICLE SEAT ELEMENT, IN PARTICULAR MOTOR VEHICLE SEAT

(71) Applicant: FAURECIA Sièges d'Automobile, NANTERRE (FR)

(72) Inventors: Mathieu CLUET, ETAMPES (FR); Fabrice CHARRAS, MONTROUGE (FR)

(21) Appl. No.: 18/677,000

(22) Filed: May 29, 2024

(30) Foreign Application Priority Data
May 30, 2023 (FR) 2305329

(51) Int. Cl. B60N 2/58

(52) U.S. Cl. CPC B60N 2/5825; B60N 2/5891

(57) ABSTRACT

A vehicle seat element, in particular a motor vehicle seat element, comprising a structure, typically metallic, a padding comprising a solidified 3D entanglement of continuous thermoplastic fibers arranged irregularly forming loops welded together, an interface located between the structure and the padding, the interface comprising a receiving surface covered at least in part by the padding, and a plurality of fastening elements for fastening the padding to the interface, each fastening element passing through at least a part of the padding and the receiving surface of the interface, transversely thereto.

### PRIORITY CLAIM

This application claims priority to French Patent Application No. FR2305329, filed May 30, 2023, which is expressly incorporated by reference herein.

### BACKGROUND

The present disclosure relates to a vehicle seat element, in particular but not exclusively motor vehicle seat, as well as a seat comprising such a seat element.

### SUMMARY

According to the present disclosure, a vehicle seat element, in particular a motor vehicle seat element, is proposed, comprising:
a. a typically metallic structure,
b. a padding comprising a solidified 3D entanglement of continuous thermoplastic fibers arranged irregularly forming loops welded together,
c. an interface located between the structure and the padding, the interface comprising a receiving surface at least partially covered by the padding, and
d. a plurality of fastening elements for fastening the padding to the interface, each fastening element passing through at least a part of the padding and the receiving surface of the interface, transversely thereto.

In illustrative embodiments, a padding made of a material other than polyurethane foam is thus available. This padding material is advantageously a recyclable plastics material and its production generates less CO₂ emissions than the production of a polyurethane foam, thus reducing the ecological impact of the seat element containing such padding. In addition to the advantages for the environment, the seat element comprising this material for the padding can make it possible to produce a substantially lighter padding than a similar polyurethane foam padding. In addition, the padding material may be more breathable, allowing air and any moisture to pass through the padding more easily.

In illustrative embodiments, the fastening provided between the padding and the interface can make it possible to secure this assembly of the padding and interface regardless of the posture or movements of the occupant of the seat.

The features disclosed in the following paragraphs can optionally be implemented independently of one another or in combination with one another:

The padding may comprise of the 3D entanglement. In this case, the plurality of fastening elements is in contact with the padding.

“The plurality of fastening elements being in contact with the padding” means that the plurality of fastening elements is in contact with an outer surface of the padding forming a bearing surface for an occupant of the seat.

Alternatively, the padding comprises a cap covering the 3D entanglement. In this case, the cap is advantageously attached to the interface. This fastening is advantageously made using the same fastening elements that pass through the cap, the 3D entanglement and the interface.

The padding may cover the entire receiving surface of the interface. Alternatively, the padding only covers a part of the receiving surface of the interface. In particular, in the latter case, the padding may comprise several distinct padding elements, connected or not to each other, each covering a part of the interface receiving the interface, at different locations thereof.

The padding may form a padding layer, in particular with a thickness of between 15 mm and 100 mm. The padding layer may have a substantially constant thickness over its entire area, for example edges that have been rounded.

The interface, in particular the receiving surface, can be made at least partially of polymer material. The interface may comprise a layer of polymer material, delimited in thickness by the receiving surface and by a surface opposite the receiving surface and comprising these. Such a layer of the interface may have a thickness of between 20 mm and 40 mm, preferably equal to 30 mm. This thickness does not include the reliefs, for example the reinforcing ribs or the like, which may be present on either of the surfaces of the interface.

The number of padding fastening elements can be between 12 and 120, in particular between 30 and 120. Such a number can make it possible to improve the fastening. The fastening elements can be arranged at regular intervals from each other, for example according to a configuration such as a grid.

Each fastening element advantageously passes through the entire thickness of the padding.

The interface preferably comprises a plurality of openings, each opening receiving a fastening element. Such openings are then formed before assembly, using the fastening elements, between the interface and the padding. Likewise, the padding may comprise a plurality of openings, each opening receiving a fastening element. In this case, the openings are formed before the assembly between the interface and the padding, in particular during the method for manufacturing the padding. In particular, the openings can be made in the padding by thermoforming, in particular at the end of the method for manufacturing the padding.

When the interface and/or the padding, preferably the interface and the padding, comprise openings formed before assembly, the quality of the fastening using the fastening elements can be improved and the retention over time of the fastening can be extended.

The padding may have an inner surface in contact with the receiving surface of the interface and, opposite, an outer bearing surface intended to face a user, the outer bearing surface being free and intended to come directly into contact with a user. By “being free” is meant “not covered”. In this case, the seat element does not have a cover, that is to say an exterior layer of appearance forming a covering, covering all or part of the seat element.

In this case, the padding may comprise a main layer forming the inner surface and an outer layer covering the main layer and forming the outer bearing surface. Such an outer layer may be obtained by rolling at the end of the method for manufacturing the padding. The outer layer may have a density greater than the density of the main layer. The abrasion resistance and the fraying of the exterior bearing surface can be improved by this rolling. In addition, the contact for the user can be more comfortable or pleasant.

At least one fastening element, or even all the fastening elements, may be formed of a single part.

As a variant, at least one fastening element, or even all the fastening elements, may be formed of two complementary parts assembled together, for example by snap-fastening, screwing, gluing or other assembly technique. In this case, one of the parts can be in contact with a surface of the interface that is opposite the receiving surface and the other of the parts can be in contact with the outer bearing surface of the padding. The two parts can cooperate with each other, for example in an inner part of the padding.

The fastening elements may be identical to each other. At least two fastening elements, or even all the fastening elements, may be arranged substantially parallel to one another.

At least one fastening element may comprise at least one head and an elongated body. The head can rest on the exterior surface, in particular the exterior bearing surface, of the padding. The elongated body can pass through all or part of the padding and interface. The head is advantageously wider than the elongated body. In particular, when it comprises the two complementary parts, the at least one fastening element may comprise two heads and at least one elongated body connecting the two heads, the heads preferably being wider than the elongated body. In this case, one of the heads can rest on the exterior surface, in particular the exterior bearing surface, of the padding. The other of the heads may rest on the surface opposite the receiving surface of the interface. The at least one elongated body connecting the two heads can pass through the padding and the interface.

The seat element may be selected from the group comprising at least one of a seat backrest, an armrest, a seat cushion, a headrest, a part thereof and a set of all or part thereof.

The seat element can form a seat backrest. In this case, the interface is a backrest interface preferably comprising at least one shell, in particular deformable, of a backrest, receiving the padding which is a backrest padding, the shell comprising the receiving surface of the interface. When deformable, the shell can be configured to take various shapes, in particular from an initial position of lumbar lordosis to a final position of kyphosis in response to a variable charge applied by the back of the occupant of the seat.

In addition, the backrest interface may comprise a system coupling the shell, when deformable, of a backrest to the structure comprising upper movement control links, and lower movement control links.

The backrest interface is advantageously made at least partially of polymer material. Such a backrest interface is ergonomic and dynamic.

The seat element can form a seat cushion. In this case, the interface is a seat interface preferably comprising at least one seat shell receiving the padding which is a base padding, the shell comprising the receiving surface of the interface.

According to another aspect, in combination with the foregoing, a vehicle seat is proposed, in particular a motor vehicle seat, comprising at least one seat element as defined above.

According to another aspect, in combination with the foregoing, a method is proposed for assembling a seat element, comprising the manufacture of a padding as defined above, the fastening of the padding to the receiving surface of the interface using the fastening elements, and the assembly of the entire padding and the interface with the structure. The method may comprise the painting of the padding, in particular after its manufacture.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a motor vehicle seat, according to one example.

FIG. 2 is a schematic cross sectional view, partially exploded, of a motor vehicle seat example.

FIG. 3 is a schematic representation of an example method for manufacturing a padding of a seat element according to one example.

FIG. 4 is a transversal cross-sectional view of an example of a padding made using the method shown in FIG. 3.

FIG. 5 shows schematically, in transversal cross section, an example of a seat element forming a seat cushion.

FIG. 6 is a schematic front view of an example of seat element forming a backrest.

FIG. 7 shows in an isolated and schematic manner, seen from behind, the interface of the seat element of FIG. 6.

FIG. 8 shows in an isolated and schematic manner, in front view, the padding of the seat element of FIG. 6.

FIG. 9 shows in an isolated and schematic manner, in front view, a plurality of fastening elements for the seat element of FIG. 6, arranged as they are in the seat element of FIG. 6.

FIG. 10 shows in front view, in an isolated and schematic manner, a finishing frame used in the seat element of FIG. 6.

FIG. 11 schematically shows, in an isolated and perspective manner, an example of a fastening element that can be used in a seat element.

FIG. 12 is a view similar to FIG. 8 of a padding of a seat element according to another example.

FIG. 13 schematically shows in front view a seat element according to one example, comprising the padding of FIG. 12.

FIG. 14 schematically shows a front view of another example of a seat element.

### DETAILED DESCRIPTION

The following drawings and description contain, for the most part, elements of certainty. They may therefore not only serve to enhance understanding of this disclosure, but also contribute to its definition, where appropriate.

In the various figures, the same references designate identical or similar elements. For simplicity's sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a vehicle seat in its normal position of use.

In particular, the longitudinal direction X is understood to mean the longitudinal direction of the seat. The longitudinal direction of the seat is considered to be the same as the longitudinal direction of the motor vehicle wherein the seat is mounted. This longitudinal direction X corresponds to the normal direction in which the vehicle advances. The longitudinal direction X is horizontal. The transverse direction Y of the seat thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat, perpendicular to the longitudinal and transverse directions.

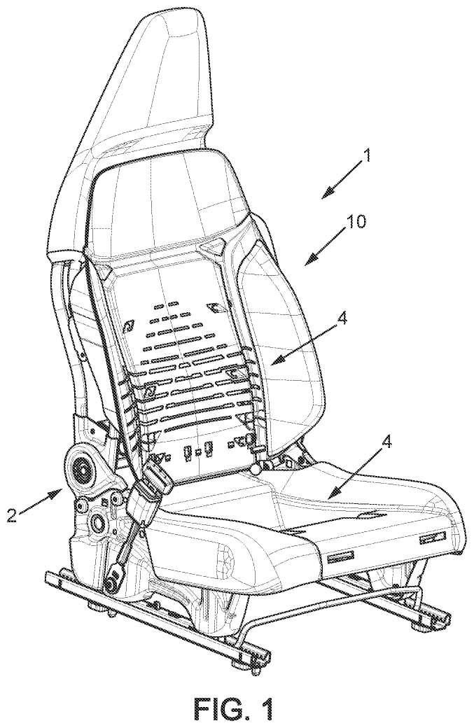

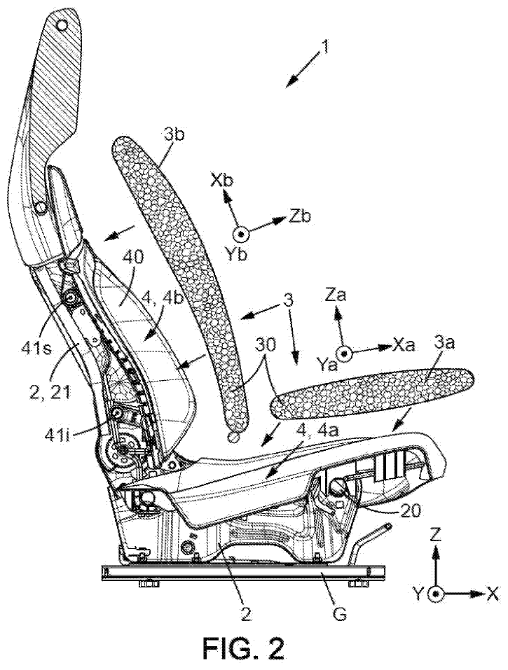

Reference is now made to FIGS. 1 and 2 representing a seat 1 comprising a backrest and a seat forming a seat element 10 comprising a typically metal structure 2, a padding 3, an interface 4 located between the structure 2 and the padding 3.

In FIG. 2, a reference frame XYZ is shown, the direction X oriented along the sliding direction of the slide G between the squab structure 2 and a floor of the vehicle, the direction Y, oriented along a transverse direction of the seat, and the direction Z along the vertical.

The structure 2 typically made of metal comprises a seat frame 20 and a backrest frame 21, articulated around a transverse axis of rotation, for example by means of articulations of the continuous type.

The seat frame 20 includes in this example two lateral flanges, extending from a rear edge of the backrest and to a front edge, along the longitudinal direction X, or slightly inclined relative to the longitudinal direction X (namely by plus or minus 30 degrees) around a transverse axis. The seat frame may also include a front part connecting two front ends of the flanges, and extending in the transverse direction. The front piece and the flanges are, for example, sheets shaped, for example, by stamping techniques.

The backrest frame 21 comprises, for example, lateral uprights, extending height wise, as well as an upper cross-member connecting two upper ends of the uprights. The uprights and the upper cross-member are, for example, shaped sheets, for example by stamping techniques.

In this example, the padding 3 comprises a seat cushion padding 3a which confers comfort of the seat and which is received on a seat interface 4a inserted between the structure 2, in particular the seat frame 20, and the seat padding 3a. In this example, the padding 3 comprises a backrest padding 3b which confers the comfort of the backrest and which is received on a backrest interface 4b which is inserted between the structure 2, in particular the backrest frame 21, and the backrest padding 3b.

The padding 3, in particular the seat cushion padding 3a and/or the backrest padding 3b, comprises a three-dimensional (“3D”) entanglement 30 of continuous, thermoplastic fibers 5 arranged irregularly, forming loops heat-sealed together between the fibers 5.

The seat cushion padding 3a extends lengthwise in a longitudinal direction Xa of the seat cushion from a rear edge to a front edge of the seat cushion, and in width along a transverse direction of the seat cushion from a first lateral edge to a second lateral edge, as well as thickness along an orthogonal direction Za, which is orthogonal to the longitudinal direction and to the transverse direction of the seat cushion. The thickness of the layer forming the seat cushion may be between 60 mm and 100 mm.

The backrest padding 3b extends length along a longitudinal direction Xb of the backrest from a rear edge to a front edge of the backrest, and width along a transverse direction Yb of the backrest from a first lateral edge to a second lateral edge, as well as thickness along an orthogonal direction Zb, which is orthogonal to the longitudinal direction and to the transverse direction of the backrest. The thickness of the layer of backrest padding may be between 20 mm and 40 mm.

The interface 4, in particular the squab interface 4a or the backrest interface 4b may comprise a material that is entirely or partially made of polymer. For example, the interface 4 is made of ABS (acrylonitrile butadiene styrene) and/or PC (Polycarbonate) and/or P/E (polypropylene/polyethylene copolymer).

In general, the interface 4, in particular the squab interface 4a or the backrest interface 4b may comprise a shell 40, namely deformable shell. The shell may be a molded part or a thermoformed part.

The padding 3 bears and at least partially covers, by an inner surface 47 of the 3D entanglement of thermoplastic continuous fibers 5, a receiving surface 46 of the interface 4, in particular the shell 40 of the seat interface 4a or the backrest interface 4b. The padding 3 forms, opposite this interior surface 47, an exterior bearing surface 32 intended to be in contact with the user and visible to the latter.

The padding 3 is preferably not bonded and not welded to the interface 4. The recycling, the padding 3, in particular the 3D entanglement of thermoplastic continuous fibers 5 forming the padding 3, which may be separated from the interface 4, are advantageously simplified.

The shell 40 of the backrest, deformable in this example, can be configured to take different shapes, namely from an initial position of lumbar lordosis and in particular to a final position of lumbar kyphosis, in response to a variable load applied by the back of the occupant of the seat.

The interface 4 may also include a system coupling the deformable shell 40 of a backrest to the structure 2 comprising upper movement control links 41s, and lower movement control links 41i. The upper movement control links 41s and/or the lower movement control links 41i are, for example, articulated links which can comprise connecting rods.

The padding 3 resting on the shell 40 is held on the shell 40 by a plurality of fastening elements 80.

The padding 3 can accompany the deformation of the shell 40, when deformable, in response to a variable load applied by the back or the thighs or the buttocks of the occupant of the seat.

In general, the interface 4, in particular the seat interface 4a or the backrest interface 4b may comprise, in a transverse direction Ya, Yb raised edges comprising a vertical component Za, Zb, on either side of a central portion 42 of the interface 4, in particular of the shell 40.

The raised edges of the interface 4 can provide for the shaping of the padding 3, in particular the base padding 3a or the backrest padding 3b. The padding 3 comprises a layer of 3D entanglement of thermoplastic fibers 5 of substantially constant thickness to form a seat cushion or a backrest and comprises, along the transverse direction Ya, Yb, a central portion and lateral holding portions, protruding from the central portion.

In the case of the seat cushion, the central portion receives the thighs and/or the buttocks of the occupant of the seat, and the lateral holding portions, arranged on either side of the central portion along the direction Ya, provide the lateral holding, for example, in turns.

In the case of the backrest, the central portion receives the back of the occupant of the seat and the lateral holding portions, arranged on either side along the transverse direction Yb, provide the lateral holding, for example, in turns.

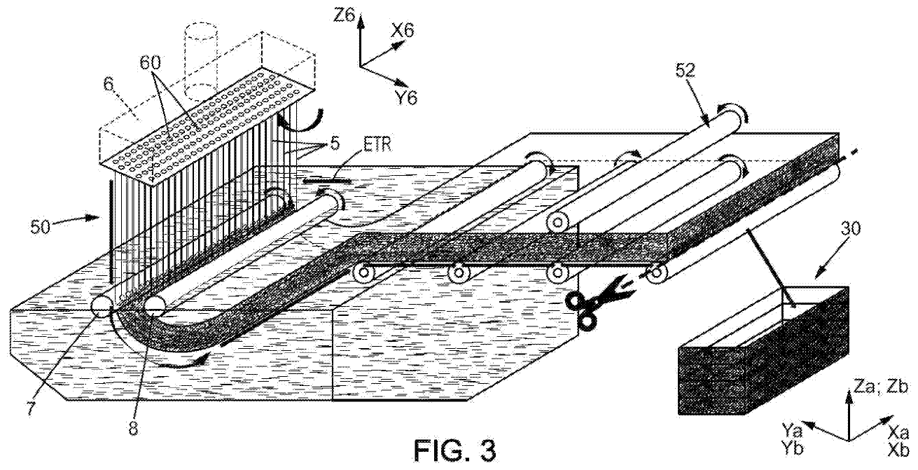

To manufacture the padding 3, the continuous manufacturing method described with reference to FIG. 3 can be implemented.

This continuous method comprises, as schematically shown in FIG. 3:
/A/ Extruding a thermoplastic polymer in an extrusion die 6 comprising extrusion nozzles 60 distributed in a lengthwise direction X6 and in a widthwise direction Y6 of the extrusion die, generating a curtain 50 of continuous molten fibers, falling by gravity,
/B/ Receiving the curtain 50 of continuous molten fibers falling under gravity between two counter-rotating guide members 7, 8, with a generation of a 3D entanglement of fibers 5 according to a random distribution, with melting of the loops between the continuous fibers, in particular according to a layer whose thickness is determined by the center distance ETR between the two guiding members 7, 8,
/C/ Solidification of the 3D entanglement of fibers by immersion in a cooling liquid, such as water,
/D/ rolling by passing between two rollers, including at least one laminating roller 52, heated to a temperature preferably comprised between 160° C. and 180° C.

The extrusion nozzles 60 are preferably distributed regularly along the lengthwise direction X6 of the extrusion die, as well as in width along the widthwise direction Y6.

The thickness of the padding layer formed by the entanglement can be adjusted, by adjusting the center distance ETR between the two guide members 7, 8.

In /B/, the two guide members 7, 8 are driven in rotation at a speed, for example, lower than the speed of fall of the fibers, providing an accumulation of the fibers at the origin of the formation of loops that are welded together between fibers, generating the irregular entanglement in three dimensions. The solidification in /C/ is obtained just after step /B/, the two guide members being able to be immersed at mid-height, for this purpose.

The extrusion temperature implemented in /A/ in the extrusion die, for example, between 180° and 240° C. The extrusion die is fed with granules of polymer.

The 3D entanglement layer of fibers, continuously running, is then guided, outside the cooling liquid reservoir to be dried, for example, by shaking/vibrations.

In /D/, an upper layer is laminated by the laminating roller 52, which creates a reduction in thickness and densification of the 3D entanglement of fibers.

The running layer is then cut, namely by transverse cuts, making it possible to obtain different paddings 3, and as can be seen in FIG. 3. These paddings 3 extend lengthwise, for example lengthwise along the longitudinal direction Xa of the seat padding layer (or in length along the longitudinal direction Xb of the backrest padding layer, for example, along the direction transverse to the passage of the layer. An abrasive treatment or thermoforming may be applied to round the edges, for example or if a 3D shape is desired.

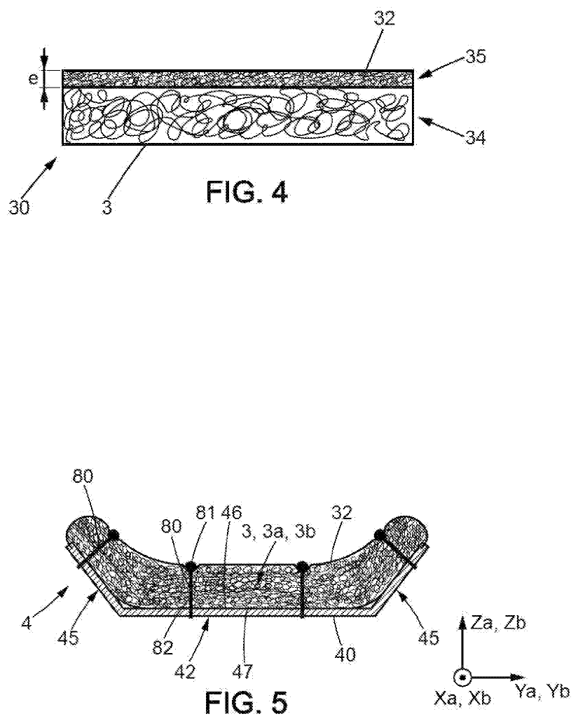

As shown in FIG. 4, after rolling of an upper layer in /D/, the entanglement 30 of fibers comprises a main layer 34 and an exterior layer 35. The exterior layer 35 has a thickness e. The thickness e is preferably between 1 millimeter and 4 millimeters. The main layer 34 has a first density of between 45 kg/m3 and 65 kg/m3. The exterior layer 35 has a second density comprised between three and eight times the first density. The entanglement 30 of fibers has an exterior bearing surface 32 of the padding 3 extending around the periphery of the entanglement 30 of fibers. The exterior bearing surface 32 is intended to face a user. The exterior bearing surface 32 belongs to the exterior layer 35. The entanglement 30 of fibers is not covered, so that the entire exterior support surface 32 is visible and is intended to come directly into contact with the user. Because the exterior layer 35 has been laminated, the abrasion resistance and the fraying of the exterior support surface 32 is improved. Furthermore, the user's contact is improved. The padding 3 does not comprise nor is covered by any cap in this example.

It is not outside the scope of the present disclosure if the density of the packing is substantially uniform, without distinguishing layers 34 and 35, for example in the absence of implementation of /D/ during the manufacturing process.

In the example of FIG. 5, a seat element comprising the interface 4 is shown, which comprises the shell 40. In this example, the padding 3 covers the entire receiving surface 46 and is attached to the interface 4 using the plurality of fastening elements 80.

The shell 40 has raised edges 45 providing the shaping of lateral holding portions, protruding on either side of a central portion 42 of the interface 4.

The fastening elements 80 pass through the padding 3 and the receiving surface 46 and the rest of the interface 4, transversely to the latter, in their thickness, and attach them together. The fastening elements 80 are all identical in this example. In this example, the fastening elements 80 are formed as a single piece. They comprise a head 81 in contact with the exterior bearing surface 32 of the padding 3, optionally pressing on it so as to slightly push the exterior support surface 32 of the padding 3, as can be seen in this FIG. 5. The fastening elements 80 comprise an elongated body 82 under the head 81, passing through the thickness, the padding 3 and the interface 4. They are in the form of screws, with the head 81 forming the screw head, larger than the elongated body 82. The fastening elements 80 may be rigid or elastically deformable. If they are rigid, it may be preferable to depress them deeply into the padding 3.

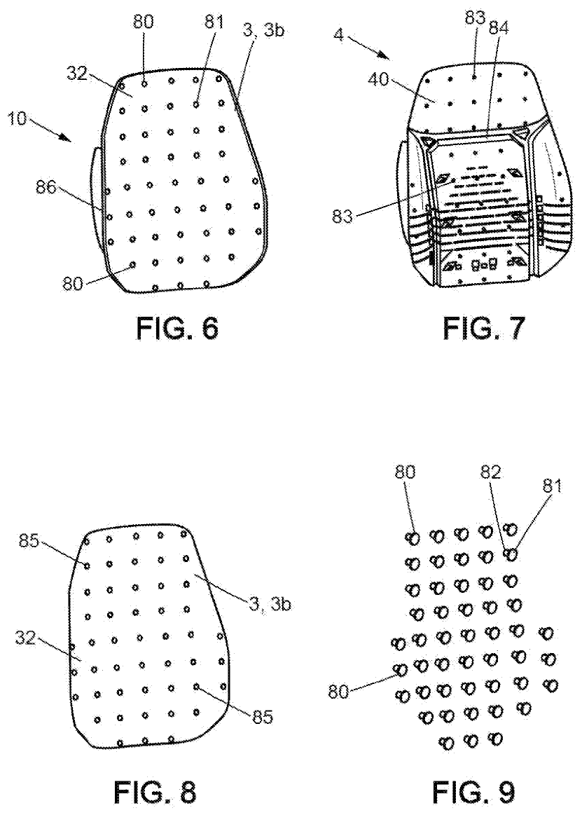

In the example of FIGS. 6 to 10, the seat element 10 comprises the backrest of the seat. As can be seen in FIG. 6, the padding 3 completely covers the interface 4. The fastening elements 80 are evenly distributed according to a regular grid whose contours are adapted to the shape of the backrest of the seat, as can be seen in FIG. 6 and also in FIG. 9. The number of fastening elements 80 per surface unit may be about 50 per m². As seen in FIG. 6, only the heads 81 of the fastening elements 80 are visible, flush with the exterior support surface 32.

As can be seen in FIG. 7, the interface 4 comprises a plurality of openings 83 formed in the shell 40 and passing through it. The shell 40 comprises a plurality of reliefs 84 forming, for example, reinforcing ribs.

The padding 3, visible in isolation in FIG. 8, comprises a plurality of openings 85 made for example during the manufacturing process, by thermoforming.

The openings 83 and 85 are through-openings forming a housing for receiving the elongated bodies 82 of the fastening elements 80. The openings 83 and 85 are distributed in the same way as the fastening elements 80, according to the same grid.

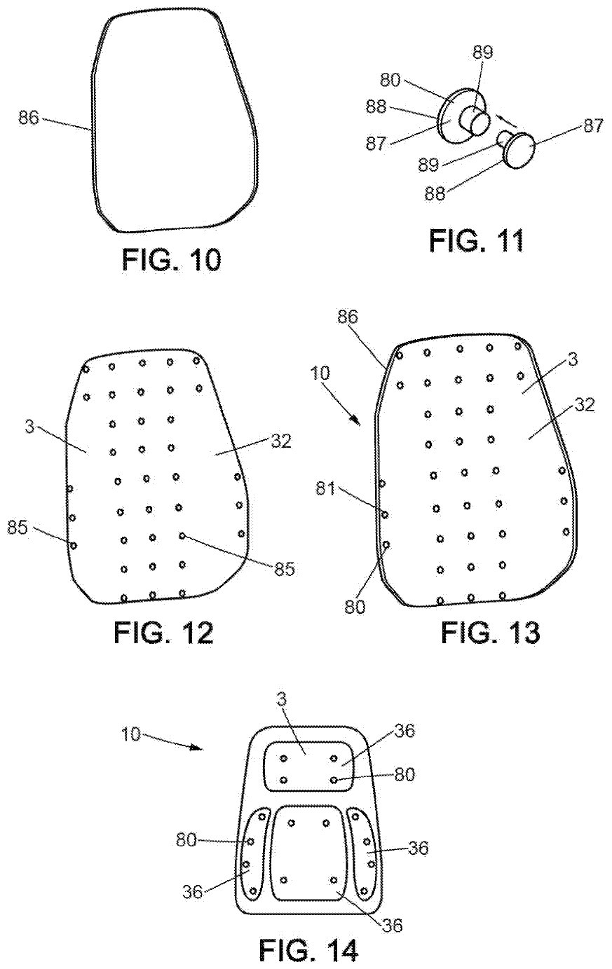

Still in this example, as shown in FIG. 10, the seat backrest comprises a finishing frame 86 surrounding the backrest of the seat and able to be provided to conceal the contour of the backrest of the seat and in particular the superposition of the padding layer 3 and the shell 40. The tubular frame 86 can only fill a decorative function and not a structural function.

In the example of FIG. 11, the fastening element 80 comprises two complementary parts 87, intended to be assembled together as the arrow shows, by snap-fastening, screwing and/or gluing, for example. Each of the complementary parts 87 comprises a head 88 and an elongated body 89 narrower than the head 88. One of the heads 88 is intended to rest against the exterior support surface 32. The other of the heads 88 is intended to rest against the surface of the interface 4, in particular of the shell 40, which is opposite the receiving surface 46. The parts 87 may or may not be identical. It is not outside the scope of the disclosure if the fastening elements 80 are different from those of the example of FIG. 9 and from the example of FIG. 11.

In the example of FIGS. 12 and 13, the positioning and the number of fastening elements 80 is made according to another embodiment. In particular, the fastening elements 80 are distributed according to a regular grid, but all the corners of the grid are not provided with fastening elements. The positioning locations of the fastening elements 80 are chosen such that the padding 3 is retained correctly against the receiving surface 46 of the interface 4, regardless of the posture and/or regardless of the movements of an occupant of the seat element 10. In this example, the number of fastening elements 80 is less than that of the example of FIGS. 6 to 10. Of course, other distribution patterns of the fastening elements 80 are possible without departing from the scope of the disclosure.

The disclosure is not limited to the examples that have just been described.

The fibers may be hollow fibers and/or solid fibers. The fibers may have a diameter comprised between 0.2 mm and 2 mm, preferentially between 0.3 mm and 1.5 mm. “Continuous” in “continuous fibers” means that the fibers have a length much greater than the diameter of the fibers, and because of the method which is described below, for example, at least a ratio of 100, or even 500, or even 1000.

The fibers 5 comprise a thermoplastic polymer, the composition of the fibers preferably comprising at least 95% by weight of PET. For example, the composition of the fibers, or of the padding comprises 95% to 99% by weight of a first polymer of the family of polyesters, such as PET (polyethylene terephthalate) and 1% to 5% by weight of a second polymer of the family of polyesters, such as PTT (polyethylene terephthalate) or PBT (polybutylene terephthalate). The sum of the PET and of the PTT (or PBT) can make 100% by weight of the fibers, or of the padding. The 3D entanglement of the padding 3 may have a bulk density between 45 kg/m3 and 65 kg/m3.

Preferably, the voids between the fibers 5 of the 3D entanglement of fibers 5 of the padding 3 are left free. A very breathable padding is obtained, because of the numerous interspaces between the fibers that promote air circulation.

The padding may cover the entire receiving surface of the interface.

Alternatively, the padding only covers a part of the receiving surface of the interface. In the latter case, the padding may comprise several distinct padding elements, connected or not together, each covering a part of the receiving surface of the interface, at different locations thereof. FIG. 14 shows an example of a seat element comprising such padding elements 36 forming the padding 3, in number of four in this example, which are distinct, arranged on the interface 4 in the manner of a patchwork. Each padding element 36 is fixed using the fastening elements 80, as visible.

In one variant, the padding 3 may comprise a covering, in particular textile, forming a cap, externally covering the 3D entanglement 30 and with which the occupant of the seat is in contact. In this case, the cap is advantageously attached to the interface 4. This fastening is advantageously made using the same fastening elements 80 which pass through the cap, the 3D entanglement and the interface.

The fastening elements 80 may be in the form of a single clip.

The vehicle seat elements, in particular motor vehicle seat elements, each comprise at least one structure, or reinforcement, as well as a lining and a cover together forming a padding, assembled with each other during assembly. There is a need to reduce the number of steps necessary during the mounting of the seat elements and the number of parts necessary for the production of these motor vehicle seat elements.

Moreover, the comparative padding of seat elements of vehicles, in particular motor vehicles, may be made of foam of urethane (or polyurethane, PU) polymer, in particular of polyurethane foam obtained from polyols of the polyether/polyol (or PUR) type. Such foams can be shaped in molds in a relatively easy manner, to form various shapes of padding for different vehicle seat elements, such as the seat cushion, backrest, armrest or headrest, for example.

Foam padding is satisfactory, but can retain moisture, in particular in humid conditions. This may induce a sensation of discomfort for an occupant of the vehicle seat, one element of which comprises such padding.

Furthermore, a polyurethane foam may be produced by mixing, inter alia, polyols with isocyanates. The chemical reaction used emits CO₂ to form a foam, the emitted CO₂ contributing to global warming.

Moreover, a polyurethane foam is not recyclable.

Also, it appears desirable, at least from the ecological point of view, to limit the use of polyurethane in the padding of vehicle seat elements.

Furthermore, there is a need to lighten the mass of a vehicle seat.

There is also a need to be able to easily change the covering of a seat by means of modules, for the ascent in range and/or for the change and/or for the replacement of worn elements, in the context of managing the reconditioning and end-of-life of vehicles.

The present disclosure improves the situation. A vehicle seat element, in particular a motor vehicle seat element, is proposed, comprising:
a. a typically metallic structure,
b. a padding comprising a solidified 3D entanglement of continuous thermoplastic fibers arranged irregularly forming loops welded together,
c. an interface located between the structure and the padding, the interface comprising a receiving surface at least partially covered by the padding, and
d. a plurality of fastening elements for fastening the padding to the interface, each fastening element passing through at least a part of the padding and the receiving surface of the interface, transversely thereto.

A padding made of a material other than polyurethane foam is thus available. This padding material is advantageously a recyclable plastics material and its production generates less CO₂ emissions than the production of a polyurethane foam, thus reducing the ecological impact of the seat element containing such padding. In addition to the advantages for the environment, the seat element comprising this material for the padding can make it possible to produce a substantially lighter padding than a similar polyurethane foam padding. In addition, the padding material may be more breathable, allowing air and any moisture to pass through the padding more easily.

Furthermore, the fastening provided between the padding and the interface can make it possible to secure this assembly of the padding and interface regardless of the posture or movements of the occupant of the seat.

The features disclosed in the following paragraphs can optionally be implemented independently of one another or in combination with one another:

The padding may comprise of the 3D entanglement. In this case, the plurality of fastening elements is in contact with the padding.

“The plurality of fastening elements being in contact with the padding” means that the plurality of fastening elements is in contact with an outer surface of the padding forming a bearing surface for an occupant of the seat.

Alternatively, the padding comprises a cap covering the 3D entanglement. In this case, the cap is advantageously attached to the interface. This fastening is advantageously made using the same fastening elements that pass through the cap, the 3D entanglement and the interface.

The padding may cover the entire receiving surface of the interface. Alternatively, the padding only covers a part of the receiving surface of the interface. In particular, in the latter case, the padding may comprise several distinct padding elements, connected or not to each other, each covering a part of the interface receiving the interface, at different locations thereof.

The padding may form a padding layer, in particular with a thickness of between 15 mm and 100 mm. The padding layer may have a substantially constant thickness over its entire area, for example edges that have been rounded.

The interface, in particular the receiving surface, can be made at least partially of polymer material. The interface may comprise a layer of polymer material, delimited in thickness by the receiving surface and by a surface opposite the receiving surface and comprising these. Such a layer of the interface may have a thickness of between 20 mm and 40 mm, preferably equal to 30 mm. This thickness does not include the reliefs, for example the reinforcing ribs or the like, which may be present on either of the surfaces of the interface.

The number of padding fastening elements can be between 12 and 120, in particular between 30 and 120. Such a number can make it possible to improve the fastening. The fastening elements can be arranged at regular intervals from each other, for example according to a configuration such as a grid.

Each fastening element advantageously passes through the entire thickness of the padding.

The interface preferably comprises a plurality of openings, each opening receiving a fastening element. Such openings are then formed before assembly, using the fastening elements, between the interface and the padding. Likewise, the padding may comprise a plurality of openings, each opening receiving a fastening element. In this case, the openings are formed before the assembly between the interface and the padding, in particular during the method for manufacturing the padding. In particular, the openings can be made in the padding by thermoforming, in particular at the end of the method for manufacturing the padding.

When the interface and/or the padding, preferably the interface and the padding, comprise openings formed before assembly, the quality of the fastening using the fastening elements can be improved and the retention over time of the fastening can be extended.

The padding may have an inner surface in contact with the receiving surface of the interface and, opposite, an outer bearing surface intended to face a user, the outer bearing surface being free and intended to come directly into contact with a user. By “being free” is meant “not covered”. In this case, the seat element does not have a cover, that is to say an exterior layer of appearance forming a covering, covering all or part of the seat element.

In this case, the padding may comprise a main layer forming the inner surface and an outer layer covering the main layer and forming the outer bearing surface. Such an outer layer may be obtained by rolling at the end of the method for manufacturing the padding. The outer layer may have a density greater than the density of the main layer. The abrasion resistance and the fraying of the exterior bearing surface can be improved by this rolling. In addition, the contact for the user can be more comfortable or pleasant.

At least one fastening element, or even all the fastening elements, may be formed of a single part.

As a variant, at least one fastening element, or even all the fastening elements, may be formed of two complementary parts assembled together, for example by snap-fastening, screwing, gluing or other assembly technique. In this case, one of the parts can be in contact with a surface of the interface that is opposite the receiving surface and the other of the parts can be in contact with the outer bearing surface of the padding. The two parts can cooperate with each other, for example in an inner part of the padding.

The fastening elements may be identical to each other. At least two fastening elements, or even all the fastening elements, may be arranged substantially parallel to one another.

At least one fastening element may comprise at least one head and an elongated body. The head can rest on the exterior surface, in particular the exterior bearing surface, of the padding. The elongated body can pass through all or part of the padding and interface. The head is advantageously wider than the elongated body. In particular, when it comprises the two complementary parts, the at least one fastening element may comprise two heads and at least one elongated body connecting the two heads, the heads preferably being wider than the elongated body. In this case, one of the heads can rest on the exterior surface, in particular the exterior bearing surface, of the padding. The other of the heads may rest on the surface opposite the receiving surface of the interface. The at least one elongated body connecting the two heads can pass through the padding and the interface.

The seat element may be selected from the group comprising of a seat backrest, an armrest, a seat cushion, a headrest, a part thereof and a set of all or part thereof.

The seat element can form a seat backrest. In this case, the interface is a backrest interface preferably comprising at least one shell, in particular deformable, of a backrest, receiving the padding which is a backrest padding, the shell comprising the receiving surface of the interface. When deformable, the shell can be configured to take various shapes, in particular from an initial position of lumbar lordosis to a final position of kyphosis in response to a variable charge applied by the back of the occupant of the seat.

In addition, the backrest interface may comprise a system coupling the shell, when deformable, of a backrest to the structure comprising upper movement control links, and lower movement control links.

The backrest interface is advantageously made at least partially of polymer material. Such a backrest interface is ergonomic and dynamic.

The seat element can form a seat cushion. In this case, the interface is a seat interface preferably comprising at least one seat shell receiving the padding which is a base padding, the shell comprising the receiving surface of the interface.

According to another aspect, in combination with the foregoing, a vehicle seat is proposed, in particular a motor vehicle seat, comprising at least one seat element as defined above.

According to another aspect, in combination with the foregoing, a method is proposed for assembling a seat element, comprising the manufacture of a padding as defined above, the fastening of the padding to the receiving surface of the interface using the fastening elements, and the assembly of the entire padding and the interface with the structure. The method may comprise the painting of the padding, in particular after its manufacture.

1. A vehicle seat element, in particular a motor vehicle seat element, comprising:
a structure,
a padding comprising a solidified 3D entanglement of continuous thermoplastic fibers arranged irregularly forming loops welded together,
an interface located between the structure and the padding, the interface comprising a receiving surface covered at least in part by the padding, and
a plurality of fastening elements for fastening the padding to the interface, each fastening element passing through at least a part of the padding and the receiving surface of the interface, transversely thereto.

2. The seat element according to claim 1, wherein the padding consists of the 3D entanglement, the plurality of fastening elements being in contact with the padding.

3. The seat element according to claim 1, wherein the padding comprises the 3D entanglement, the plurality of fastening elements being in contact with the padding.

4. The seat element according to claim 1, wherein each fastening element passes through the padding throughout its thickness.

5. The seat element according to claim 1, wherein the interface comprises a plurality of openings, each opening receiving a fastening element.

6. The seat element according to claim 1, wherein the padding comprises a plurality of openings, each opening receiving a fastening element.

7. The seat element according to claim 1, wherein the number of fastening elements per m² of the padding is between 12 and 120.

8. The seat element according to claim 1, wherein at least one fastening element is formed of a single piece.

9. The seat element according to claim 1, wherein at least one fastening element is formed of two parts complementary and assembled together.

10. The seat element according to claim 1, wherein the padding has an inner surface in contact with the receiving surface of the interface and, opposite, an outer bearing surface intended to face a user, the outer bearing surface being free and intended to come directly into contact with a user.

11. The seat element according to claim 1, selected from at least one of a seat backrest, an armrest, a seat cushion, a headrest, a part thereof and a set of all or part thereof.

12. The seat element according to claim 1, forming a seat backrest, wherein the interface is a backrest interface comprising at least one shell, in particular deformable, of a backrest, receiving the padding which is a backrest padding, the shell comprising the receiving surface and being configured to take various shapes, in particular from an initial position of lumbar lordosis to a final kyphosis position in response to a variable load applied by the back of the occupant of the seat.

13. The seat element according to claim 1, wherein the padding comprises several distinct padding elements, connected or not together, each covering a part of the receiving surface of the interface, at different locations thereof.

14. The seat element according to claim 1, wherein the padding comprises a cap covering the 3D entanglement, the cap being attached to the interface.
